(19) United States
(12) Patent Application Publication
(10) Pub. No.: US 2016/0109348 A1
(43) Pub. Date: Apr. 21, 2016

(54) SYSTEM FOR MEASURING SHEAR STRESS OF A FLUID WITH ENHANCED SENSITIVITY

(71) Applicant: Commissariat a l'energie atomique et aux energies alternatives, Paris (FR)

(72) Inventors: Philippe ROBERT, Grenoble (FR); Caroline COUTIER, Grenoble (FR)

(73) Assignee: Commissariat a l'energie atomique et aux energies alternatives, Paris (FR)

(21) Appl. No.: 14/885,433

(22) Filed: Oct. 16, 2015

(30) Foreign Application Priority Data
Oct. 17, 2014 (FR) 14 60024

(51) Int. Cl. G01N 11/02

(52) U.S. Cl. CPC G01N 11/02

(57) ABSTRACT

A measurement system of a tangential force applied by a fluid is provided. The system includes a pipe in which the fluid flows, the pipe includes an inner surface contacting the fluid, and a cavity arranged in the inner surface of the pipe: and a MEMS and/or NEMS device measuring the tangential force including a support, a moving plate suspended from the support by a pivot link, the moving plate including a first face on which the fluid applies a tangential force. The device is fixed to the pipe such that the first face of the moving plate is flush with the inner surface of the pipe. The device includes two piezoresistive strain gauges suspended between the moving plate and the support, the tangential force applying force to the gauges.

### TECHNICAL DOMAIN AND STATE OF PRIOR ART

This invention relates to a system with increased sensitivity for measuring a tangential force, for example to be used to make flow meters, preferably microelectromechanical and/or nanoelectromechanical systems with increased sensitivity.

There are several categories of flow meters, including flow meters using the parietal stress or shear stress measurement on the wall of the pipe in which the fluid flows, a stress that exists for any fluid with a viscosity. A fluid has a zero velocity at the contact zone with the wall of the pipe. Moreover, any difference in the velocity within a viscous fluid introduces shear stresses, and the fluid particles traveling faster being slowed down by others traveling more slowly.

Flow meters include hot wire flow meters that operate based on the principle of heat transfer, the rate of temperature drop in the heating wire depending on the fluid flow to be measured.

There are also obstacle flow meters, in which an obstacle is placed in the flow for which the flow rate is to be measured, the pressure is measured on each side of the obstacle, the pressure difference being proportional to the shear stress on the wall.

These hot wire and obstacle flow meters make use of an indirect measurement method because they do not allow to provide the flow value directly. Therefore, the use of these flow meters requires good knowledge of the fluid to be measured and prior calibration depending on the different flow conditions.

Floating element flow meters also exist. These flow meters comprise a plate type element and operate by measuring the tangential force applied to the moving plate by the fluid. For example, the sensor may be mounted free to move in a recess in the wall of the pipe in which the fluid flows, such that the plate is flush with the inner surface of the pipe. This element moves under the tangential forces applied to it. The value of the shear stress can be deduced directly from the displacement of the moving element. Therefore, these flow meters use a direct determination method. However, the spatial resolution and the time resolution are usually low. The use of flow meters made from MicroElectroMechanical systems (MEMS) can give a good spatial resolution.

The document “A Microfabricated Floating-Element Shear Stress Sensor Using Wafer-Bonding Technology”—Javad Shajii, Kay-Yip Ng, and Martin A. Schmidt—Journal Of Microelectromechanical Systems, Vol. I, No. 2, June 1992 discloses a flow meter with piezoresistive detection. The flow meter comprises a floating element composed of a plate suspended by four arms. The arms are used as both mechanical support for the plate and piezoresistive strain gauges. The length of the suspension arms is arranged along the direction of the flow under the effect of the fluid passage, the displacement of the plate induces a compression stress on the two arms located downstream and a tension stress on the two other arms located upstream. The measurement is then made by a half Wheatstone bridge. The suspension arms forming the measurement gauges are relatively large, such that the flow meter is not very sensitive.

The document “Design and characterization of microfabricated piezoresistive floating element-based shear stress sensors” A. Alvin Barlian, Sung-Jin Park, Vikram Mukundan, Beth L. Pruitt—Sensors & Actuators, A. 2007; 134:77-87 also discloses a floating element flow meter with piezoresistive detection. In this document, the arms are loaded in bending and their deformation is measured by piezoresistive strain gauges located on the side of the bending arms. Working in bending tends to reduce the sensitivity of the flow meter.

### PRESENTATION OF THE INVENTION

Consequently, one purpose of this invention is to provide a system with increased sensitivity for measuring the tangential force applied by a fluid onto a floating element.

The purpose described above is achieved by a system comprising a pipe in which the fluid flows and a tangential force sensor located in a cavity of an inner surface of the pipe, the tangential force sensor comprising a suspended moving plate comprising a face on which the fluid applies the tangential force. The sensor is arranged in the cavity such that the face of the moving plate on which the fluid applies the tangential force is flush at least with the inner surface of the pipe surrounding the cavity. The moving plate is hinged at a support by at least one pivot link. The system also comprises at least a piezoresistive gauge suspended between the moving plate and the support and separate from the pivot link, the gauge being arranged such that the displacement of the moving plate about the pivot link generates a stress in the gauge mainly along the centre line of the gauge such that an almost pure compression stress or an almost pure tension stress is applied to it. Furthermore, the strain gauge is arranged such that the stress applied by the fluid to the moving plate is amplified by a lever effect.

The measurement system has improved sensitivity.

According to the invention, the sensor is placed in a cavity located in the inner surface of the pipe such that the moving plate is located in the zone in which there is a velocity gradient in the fluid between its velocity in the pipe and its zero velocity at the inner surface of the pipe, and a shear stress is applied to it. The sensor is such that it measures the force mainly or even only on the surface of the moving plate that is flush with the inner surface of the pipe, and that no force or almost no force is applied on the surface of the moving plate that is opposite the surface flush with the inner surface of the pipe.

Furthermore, the mechanical support function of the moving plate is separated from the piezoresistive measurement function of the displacement of the moving plate. Thus, the mechanical function and the measurement function can be optimised separately. More particularly, the piezoresistive gauge(s) may be thinner than the moving plate, to obtain a stress concentration and a sensor with better sensitivity.

The suspended gauge(s) is (are) more stable, particularly in temperature, than piezoresistive sensors with implanted gauges.

Furthermore, the gauge(s) function(s) practically in pure tension or pure compression, which further improves sensitivity and linearity.

This enhanced sensitivity means that the size of the moving plate can be reduced to obtain a better spatial resolution.

Very advantageously, the tangential force sensor may be used to form a flow meter or a flow sensor. The shear stress applied by a fluid to an element is a force applied by the fluid tangentially to the surface of this element. Thus, the measurement of a tangential force applied by the fluid is equivalent to measuring the shear stress applied by the fluid to this element.

The system according to the invention may also be made more reliable relatively easily, for example regarding parasite flows or pollution (dust, debris) in the fluid, for example by adding a film made from a flexible material so as to form a barrier to the fluid between the moving plate and the support. For example, this could be a film encapsulating all or some of the moving plate.

The subject-matter of this invention is then a system for measuring a tangential force applied by a fluid, said system comprising:
a pipe in which the fluid is intended to flow, the pipe extending over at least a portion along a given direction called the flow direction, the pipe comprising an inner surface that will be in contact with the fluid, and at least one cavity located in said inner surface of the pipe,
at least one MEMS and/or NEMS device for measuring the tangential force comprising a support with a median plane and a moving plate, said moving plate being suspended from the support by at least one pivot link, said pivot link having a centre line perpendicular to the median plane of the support, said moving plate comprising a first face on which the fluid applies a tangential force and a second face opposite the first face, said device being fixed to the pipe and being located in the cavity such that the first face of the moving plate is flush with at least a zone of the inner surface of the pipe surrounding the cavity, said device also comprising at least one suspended piezoresistive strain gauge mechanically connected to the moving plate and the support, said gauge being arranged in the cavity such that the tangential force applied by the fluid along the flow direction to the first surface of the moving plate applies a compression or a tension force to said piezoresistive strain gauge.

In this application, “plate” refers to any element with a surface larger or very much larger than its thickness, regardless of its geometry.

The cavity may or may not pass through the pipe wall.

The distance separating the plane containing the first face of the moving plate and the plane containing at least the zone surrounding the cavity is preferably less than or equal to 200 μm and advantageously less than or equal to 100 μm.

The gauge is advantageously arranged as close to the axis of the pivot link as possible.

The measurement system may advantageously comprise at least two gauges mounted in differential and electrically connected as a half Wheatstone bridge or at least four gauges mounted in differential and electrically connected as a Wheatstone bridge.

In one example embodiment, the moving plate is suspended from the support by two pivot links, said device comprising at least two piezoresistive gauges. At least one rigid force transmission arm can connect the moving plate to each pivot link, at least one piezoresistive strain gauge being suspended between a force transmission arm and the support.

Advantageously, each force transmission arm is connected to the moving plate by at least elastically deformable means at least along the direction perpendicular to the fluid flow.

The strain gauge(s) may be between 100 nm and 500 nm thick and the moving plate may be between 3 μm and 40 μm thick.

According to an additional characteristic, the pivot link comprises two beams with approximately equal lengths anchored onto the support at two separate points and anchored onto the moving plate at a point through which the axis of the pivot link passes.

Advantageously, the measurement system comprises means for limiting the fluid flow between the moving plate and the support.

These means may be formed by structuring the support and/or the moving plate so as to form at least one low flow section zone between the support and the moving plate. For example, structuring is done on the second face of the moving plate and/or on a zone of the support facing said face.

Advantageously, the measurement system comprises means of preventing fluid flow between the moving plate and the support. According to one example embodiment, these means may comprise a flexible element at least partially encapsulating the moving plate and preventing fluid from flowing between the moving plate and the support.

For example, the element is a polymer or a polyimide.

According to another example embodiment, the means for preventing fluid flow between the moving plate and the support comprise a film made from a flexible material covering the first face of the moving plate and at least part of the support.

The moving plate may comprise slots, said slots being closed off by the flexible element or the film.

The measurement system may advantageously comprise means to reduce the sensitivity to accelerations and parasite vibrations. These means may comprise a counterweight fixed to the moving plate and protected from the fluid so that no tangential force is applied to it.

Another subject-matter of the invention is a system to measure the flow rate of a fluid flowing in a pipe comprising at least one measurement system according to the invention.

Another subject-matter of the invention is a method of making a measurement system according to the invention, this method comprising:
the formation of a cavity in the inner surface of a pipe,
manufacturing of a tangential force measurement device from a stack formed from a substrate, a sacrificial layer and at least a first layer of a conducting or semi-conducting material, comprising formation of at least one piezoresistive gauge in the first layer, formation of the moving plate and the at least one pivot link in said stack and release of the gauge, the moving plate and the pivot link.

The cavity formed may be through or not through.

After the gauge has been formed, a protection portion may be formed on said gauge before the formation of a second layer from a conducting or semiconducting material on the first layer from a conducting or semiconducting material.

Subsequent to the formation of the protection portion, the second layer from a semiconducting, conducting or insulating material may be formed on the first layer from a conducting or semiconducting material, and the moving plate and the pivot link may be made at least partially in this second layer.

In one example, the method may comprise a step for filling at least the lateral gap between the moving plate and the support, said filling for example being done by spin-coating to form means of preventing fluid flow between the moving plate and the support.

In another example, the method may comprise a step in which a film is formed on the moving plate and on at least part of the support so as to close off the lateral gap between the moving plate and the support, said film for example being formed by rolling to form means of preventing the fluid flow between the moving plate and the support.

### BRIEF DESCRIPTION OF THE DRAWINGS

This invention will be better understood based on the following description and appended drawings on which:

FIG. 1A is a top view of an example embodiment of a tangential force measurement system according to the invention comprising two piezoresistive gauges mounted in differential;

FIG. 1B is a sectional view along plane A-A in FIG. 1A, the cavity not being shown;

FIG. 2 is a diagrammatic sectional view of the system in FIG. 1A;

FIG. 3 is a top view of an example embodiment of a tangential force sensor comprising four piezoresistive gauges mounted in differential;

FIG. 4 is a top view of a variant embodiment of the tangential force sensor in FIG. 3 mounted in differential;

FIG. 5 is a top view of another example embodiment of a tangential force sensor comprising four piezoresistive gauges mounted in differential;

FIG. 6A is a top view of an example embodiment of a tangential force sensor in which the effects of a parasite fluid flow under the plate are reduced;

FIG. 6B is a sectional view of the device in FIG. 6A along plane B-B;

FIG. 7A is a top view of another example embodiment of a tangential force sensor in which the effects of a parasite fluid flow under the plate are reduced,

FIG. 7B is a sectional view of the device in FIG. 7A along plane C-C;

FIG. 8A is a top view of a variant embodiment of a tangential force sensor in FIG. 7A;

FIG. 8B is a sectional view of the device in FIG. 8A along plane D-D;

FIG. 9A is a top view of a variant embodiment of a tangential force sensor in FIG. 7A;

FIG. 9B is a sectional view of the device in FIG. 9A along plane E-E;

FIG. 10A is a top view of a variant embodiment of a tangential force sensor in FIG. 7A;

FIG. 10B is a sectional view of the device in FIG. 10A along plane F-F;

FIG. 11A is a top view of another example embodiment of a tangential force sensor in which the sensitivity to parasite accelerations and vibrations is limited;

FIG. 11B is a sectional view of the sensor in FIG. 11A along plane G-G;

FIG. 12A is a top view of another example embodiment of a tangential force sensor in which the tangential force applied to the sensor is increased;

FIG. 12B is a sectional view of the sensor in FIG. 13A along plane H-H;

FIGS. 13A to 13G are diagrammatic top and sectional views of different steps in the manufacture of a tangential force sensor according to one example embodiment of the invention;

FIG. 14 shows an electrical diagram for measurement with a half Wheatstone bridge;

FIGS. 15A to 15C show diagrammatic views of the assembly of a tangential force sensor in a pipe.

### DETAILED PRESENTATION OF PARTICULAR EMBODIMENTS

This invention applies to a system for measuring the tangential force applied by a fluid, regardless of whether it is a liquid or a gas. This system can very advantageously be used to make a flow measurement device. In the remainder of this disclosure, the system is described in a flow measurement application, but it will be understood that this is in no way limitative, and all examples and variants described are applicable to a tangential force measurement system in general. The expressions “shear stress” and “tangential force” are used indistinctly, the tangential force or shear stress is shown diagrammatically by an arrow denoted F.

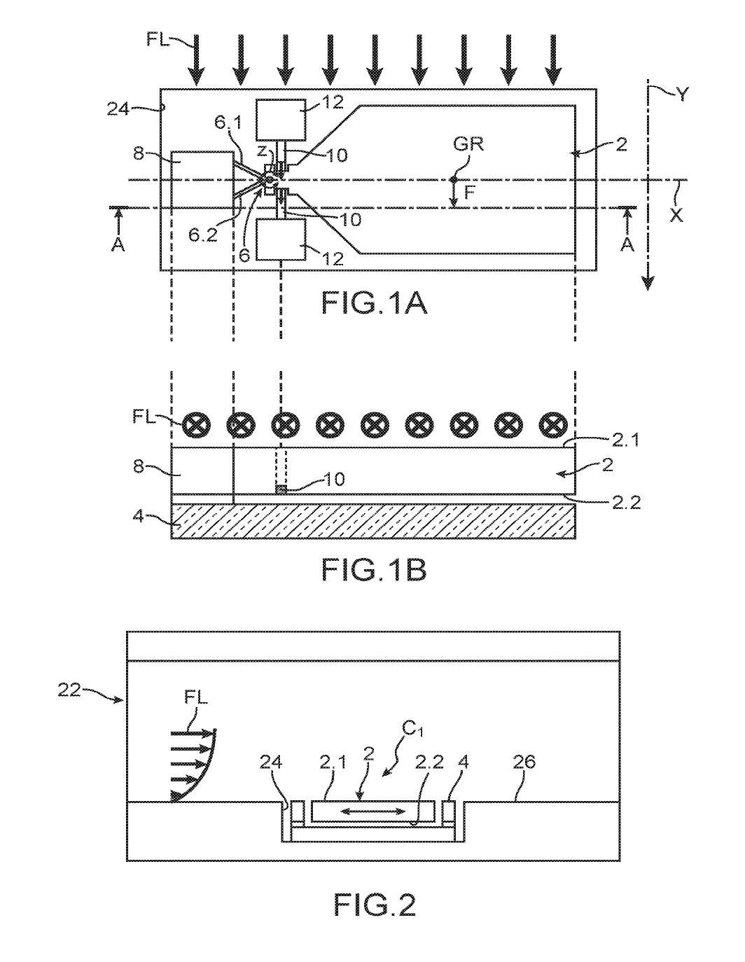

FIG. 1A shows an example embodiment of a flow sensor denoted C1 installed in a recess 24 in a pipe 22 in which the fluid flows. More generally, the sensor is installed in a cavity arranged in the pipe wall. The cavity may or may not be a through cavity. The seal for a through cavity may be obtained by the sensor assembly as will be explained below.

Sensor C1 comprises a moving part 2 having a plate-shape and a support 4. The plate 2 is free to move in the plane of the sensor denoted XY.

The moving plate 2 will be displaced by the fluid for which the flow is to be measured. The fluid flows along a direction Y and is symbolically marked by arrows FL.

The moving plate 2 is suspended from the support 4. A pivot link 6 with axis Z connects the moving plate 2 to the support. The Z axis is orthogonal to plane XY.

In the example shown, the pivot link 6 is formed by two beams 6.1, 6.2 flexible in the plane, the beams being fixed at one end to the pad 8 forming a embedment fixed to the support 4. The two beams are fixed to the pad 8 at two distinct points and at another end to the moving plate 2 at a common point defining the Z axis of the pivot. This configuration advantageously enables pure or practically pure rotation of the moving plate 2 about the Z axis.

As a variant, the pivot link may be formed by a single beam deforming in bending, the pivot axis being located approximately at the centre of the beam.

In the example shown, the sensor also comprises two piezoresistive strain gauges 10 of the suspended beam type, between the moving plate 2 and the second pads 12 forming the embedment.

The gauges extend along the Y axis along the direction of the flow for which the flow rate is to be measured. They are located on each side of the moving plate 2 so that they are loaded in pure or almost pure tension or compression. They are also mounted in differential; when the moving plate 2 moves around the Z axis, one is stressed in tension and the other is stressed in tension.

The X axis and the Z axis define a plane of symmetry of the pivot link 6.

The centre of gravity of the moving plate is denoted GR and is contained in said XZ plane. In this example embodiment, the device is oriented such that the plane containing the Z axis and the centre of gravity GR is perpendicular to the Y direction.

The following describes operation of a piezoresistive strain gauge. When the gauge is deformed along its axis and its length changes, its electrical resistance also changes and the tangential stresses applied to the fluid can be deduced by measuring this variation in resistance. The variation in the electrical resistance is measured by circulating an electrical current in the gauge 10.

A lever arm effect is developed due to the arrangement of gauges about the rotation axis, amplifying the stress applied to the gauges.

Very advantageously and as shown, the gauges are connected to the moving plate as close to the Z pivot axis as possible. Thus, they benefit from the largest possible lever arm effect. Preferably, the distance between the Z pivot axis and the projection onto the X axis of their attachment point to the moving plate is of the order of a few μm, for example 5 μm.

Means (not shown) are associated with the device C1 for applying a constant tension to gauges 10, and for measuring a variation in the current circulating in the gauges and for the treatment of current variation measurements.

In the example shown, the moving plate 2 comprises a first wider parallelepiped shaped part 14, a second trapezoidal shaped part 16 for which the large basis is common to one side of the first part and a third part 18 connected to the pivot link 6. The moving plate 2 is approximately symmetrical about the X axis. The third part 18 is also parallelepiped in shape, and its narrowest width is coincident with the small base of the second part.

The moving plate 2 is usually monolithic, the division into three parts being intended to simplify the description, and not being necessarily representative of the practical fabrication.

The gauges 10 are connected to the moving plate at the third part 18. Advantageously, recesses 20 are made in the third part 18 of the moving plate on each side of the X axis so that the gauges 10 can be connected to the moving plate at a location on the X axis or as close as possible to it. This configuration has the advantage that all or almost all stress intensity applied due to the displacement of the moving plate 2 participates in the deformation of strain gauges 10 along the Y axis. When the anchorage of the gauges 10, 8 is offset from the axis passing through the pivot link and the centre of gravity GR, part of the stress causing the strain applies a bending force on the gauge combined with a compression or tension force, this bending force not participating or participating only very slightly in the variation of the electrical resistance of the piezoresistive gauges 8.

It will be understood that the shape of the moving plate in FIG. 1A is not limitative, and it may be any parallelepiped shape, for example square, or it may be hexagonal or round or oval.

In the example shown, two gauges are used enabling advantageously a differential assembly, which limits drifts in the sensor, particularly temperature drifts. However, a flow sensor comprising a single piezoresistive gauge is not outside the scope of this invention.

FIG. 2 shows a sectional view of the system in FIG. 1A different from that in FIG. 1B in which the pipe 22 and the recess 24 are shown.

The sensor C1 is installed in the recess 24 in the pipe wall, the support 4 of the sensor being fixed to the bottom of the recess 24 such that the top face 2.1 of the moving plate 2 is flush with the inner surface 26 of the pipe. The sensor is oriented in the pipe such that the fluid flow direction is parallel to the Y axis. It is assumed that the top face 2.1 is flush with the inner surface 26 of the pipe when, preferably, the distance separating the top surface 2.1 of the moving plate and the inner surface 26 of the pipe is less than or equal to 200 μm, preferably less than or equal to 100 μm, the top surface 2.1 possibly being set back or projecting from the inner surface 26 of the pipe 22.

The distance between the lower face 2.2 of the moving plate and the support is typically less than 10 μm, which can limit the occurrence of a flow under the moving plate.

Preferably, the gap between the side edges of the mass that are parallel to the X axis and the support is typically less than 5 μm, which means that there is little flow and advantageously no flow between the side edges and the support on the thickness of the moving mass, which makes parasite effects negligible.

The operation of the shear and stress measurement system will now be described:

The fluid F circulating in the fluid channel applies a shear stress on the inner surface of the pipe and therefore on the moving plate flush with the surface 26, which tends to rotate it about the Z pivot axis. The displacement of this moving plate induces a stress in the suspended piezoresistive gauges 10. This stress makes the resistance of gauges vary. The measurement of this resistance variation that is proportional to the shear stress applied to the moving plate 2, and therefore proportional to the flow in the channel, can be read using a half Wheatstone bridge.

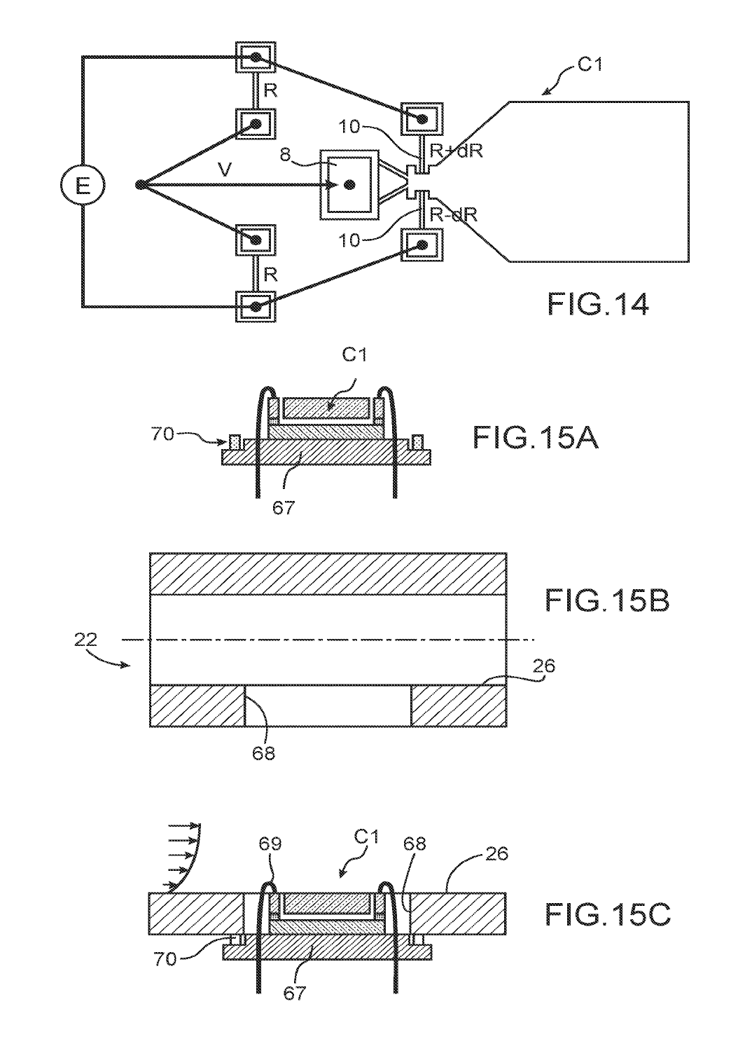

FIG. 14 shows the electrical setup associated with the sensor C1 for making measurements using a half Wheatstone bridge. The assembly as a half Wheatstone bridge is well known to those skilled in the art and will not be described in detail. A voltage source E is used with resistances R with a constant value formed for example by fixed gauges and the gauges form variable resistances with value R+dR. The current variation is determined by measuring the voltage variation V on the first anchor pad 8.

As will be described below, a full Wheatstone bridge or even a quarter of Wheatstone bridge can be used.

According to the invention, the moving plate is held in position mechanically by a means distinct from the measurement means, these measurement means can then advantageously have a small cross-section so that stresses can be concentrated and therefore the sensitivity can be increased while retaining sufficient stiffness for the moving plate. FIG. 1B shows a sectional view of the gauges 10. The gauge thickness is very much less than the thickness of the moving plate and of the beams forming the pivot link. For example, the gauge(s) may be between 100 nm and 500 nm thick and the moving plate may be between 3 μm and 40 μm thick. Furthermore, the width of the gauge(s) is small, for example less than 1 μm.

According to one example embodiment, the face of the gauge 10 facing the substrate 4 is located in the same plane as the face of the moving plate 2 facing the substrate 4.

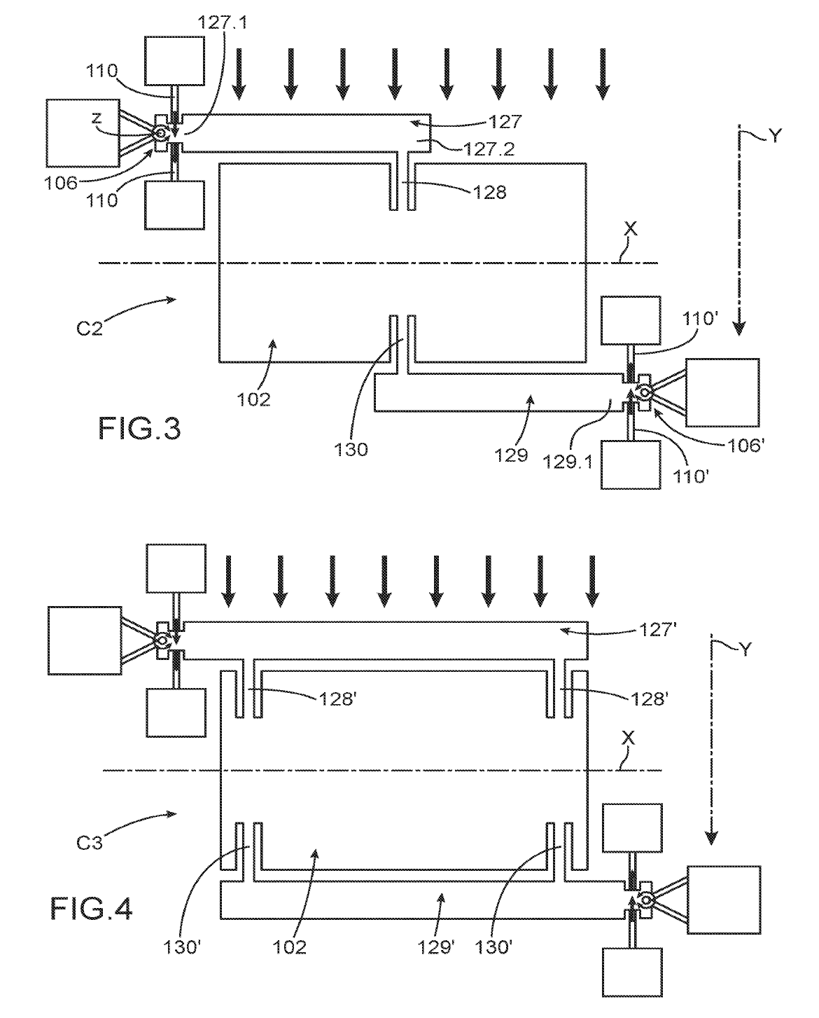

FIGS. 3, 4 and 5 show example embodiments of flow sensors making use of two pairs of piezoresistive gauges thus forming a complete Wheatstone bridge.

In FIG. 3, the sensor C2 comprises a moving plate 102 in the form of a rectangle with its largest dimension along the direction of the X axis. The moving plate 102 is suspended by two pivot links 106, 106′ installed on each side of a plane of symmetry of the moving plate 102 containing the X axis and perpendicular to the median plane of the structure.

The moving plate is connected to each pivot link through a force transmission arm 127 extending parallel to the X axis. The arm is connected at a first longitudinal end 127.1 to the support through the pivot link 206 and at a second longitudinal end 127.2 to the moving plate. The arm forms a rigid link. Moreover, two gauges 110 are suspended between the first end 127.1 of the arm 127 and the support 104 in order to measure the rotation movement of the arm 127 in the plane about the Z axis. The gauges are mounted in differential.

Advantageously, the arm 127 is connected to the moving plate 102 by means that are elastically deformable at least along the X axis so as to transmit the maximum force applied by the fluid onto the moving plate, to the rigid link without hindering the movement of the moving plate 102. These elastic means 128 give degrees of freedom between the moving plate 102 and the transmission arm 127, forming elastic relaxation means. In the example shown, the elastic means 128 are formed by a flexible blade.

The second transmission arm 129 extends along the edge of the moving plate opposite the edge along which the first transmission arm 127 extends and is connected to the support by a second pivot link, this second pivot link being located on the side of the Y axis and the flow opposite the first pivot link. As for the first transmission arm 127, the second transmission arm 129 is advantageously connected to the moving plate 102 by elastic means 130 that are deformable at least along the direction of the X axis. Two gauges 110′ are suspended between the first longitudinal end 129.1 of the second transmission arm 129 and the support. The gauges are mounted in differential.

The four gauges 110, 110′ are electrically connected so as to form a complete Wheatstone bridge.

FIG. 4 shows another variant embodiment C3 of the sensor in FIG. 3, in which each transmission arm 127′, 129′ is connected to the moving plate at two distinct points, advantageously by two transmission means 128′, 130′. This variant provides a higher stiffness along the direction Z and a higher torsional stiffness about the Y axis than the sensor in FIG. 3.

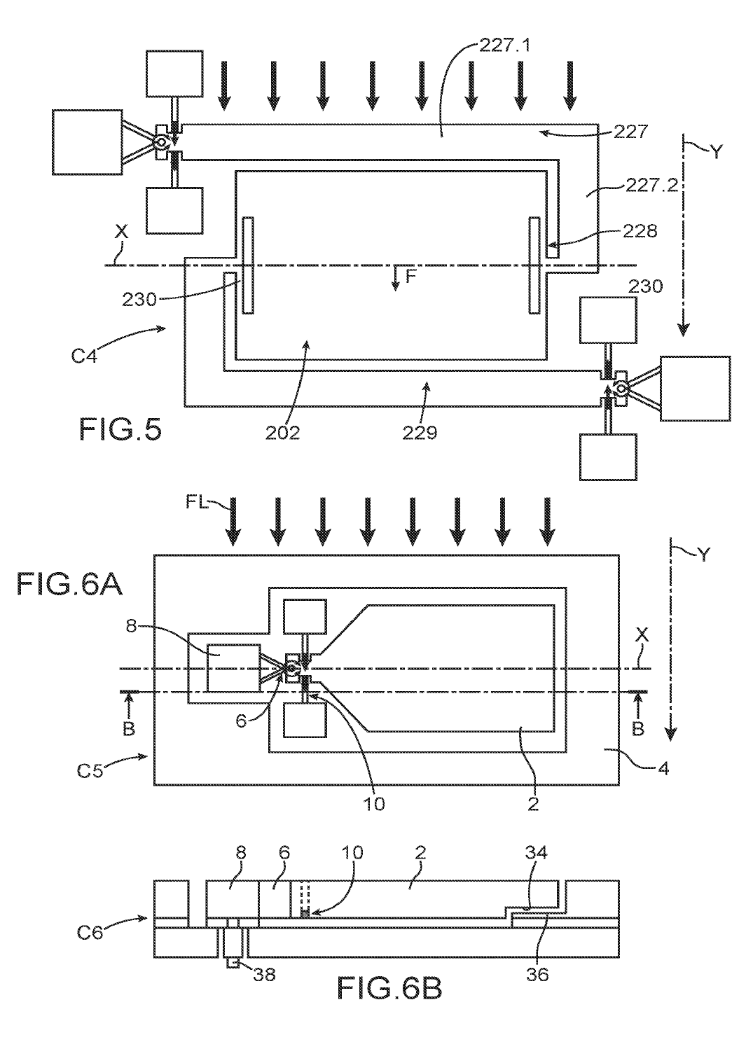

FIG. 5 shows another variant C4 of the sensor in FIG. 3, in which the transmission arms 227, 229 are connected to the moving plate 202 at its longitudinal ends along the X axis. The arms are then L-shaped, with one arm 227.1 of the L running along the longest length of the moving plate and one arm 227.2 of the L running along the shortest length. Amplification of the stress due to the lever arm is increased because the transmission arms are connected to the moving plate at their longitudinal ends opposite the ends from which the gauges are suspended.

Advantageously, the arms 227, 229 are connected to the moving plate 202 by elastic means 228, 230 that are elastically deformable along the direction of the X axis. In this variant, the elastic means are formed by cutting two rectangular shaped slots in the moving plate 202 along the direction of the X axis so as to form two narrow strips in the moving plate 202 extending along the shortest edge of the plate 202. They then provide elasticity along the X direction.

The fluid for which the flow rate is to be measured flows in the pipe, along the X axis on the top surface of the moving plate, and moves the moving plate along the Y axis due to shear stresses. The moving plate is suspended above the support, and there is a space between the side edges of the moving plate and the support and between the lower face of the moving plate and the support. Fluid can flow between the moving plate and the support, and can apply a parasite force onto the moving plate and thus distorts the measurements. The examples shown in FIGS. 6A to 11B comprise means for reducing or even eliminating these parasite forces.

FIGS. 6A and 6B show an example embodiment of a flow sensor C5 in which the moving plate and the support are structured to limit the parasite flow. The moving plate and the support are structured so as to delimit at least a reduced cross-sectional passage zone for the fluid. Preferably and in the example shown, the lower face of the moving plate 2 comprises an offset 34 and the support 4 comprises a corresponding offset 36 facing it that together delimit a cross-sectional passage smaller than the cross-sectional passage normally delimited between the moving plate 2 and the support 4. The fluid flow that can flow under the plate is thus reduced. By structuring the lower face of the moving plate, the lateral gap between the moving plate and the support is not necessarily reduced. As a variant, only the support or the face 2.2 of the moving plate may be structured.

Furthermore, the electrical connections 38 are preferably formed on the back face, preventing the presence of projections on the front face in the flow in order to limit flow disturbances. This is applicable to all devices according to the invention. Connections are made for example by TSV (Through Silicon Vias).

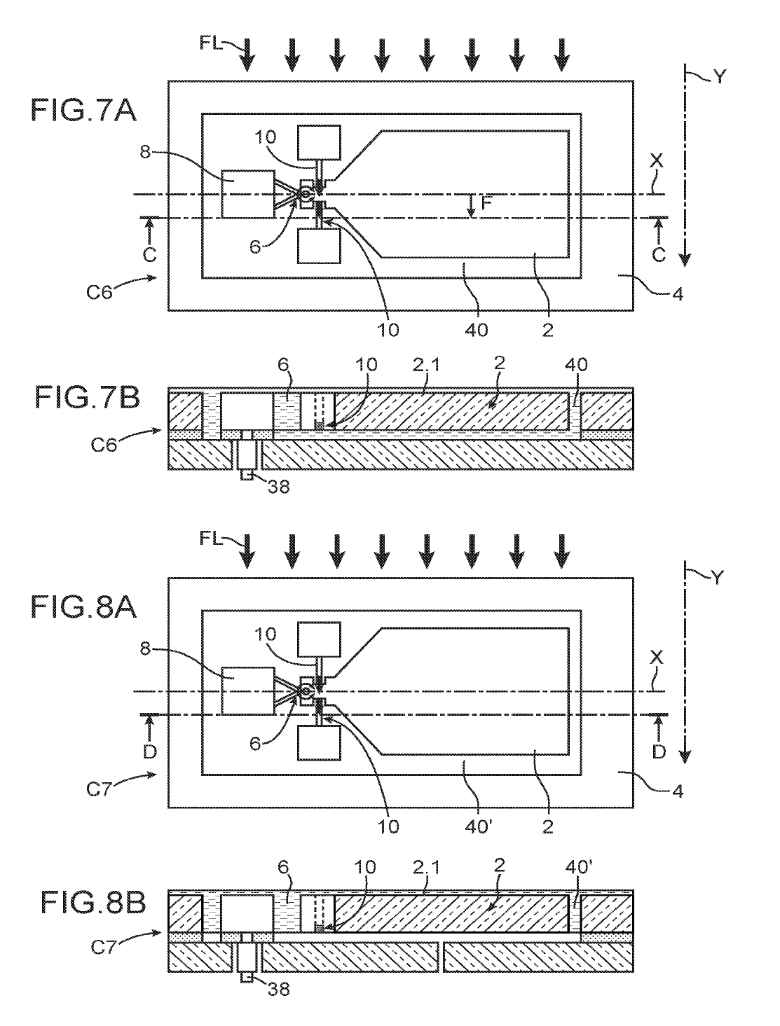

FIGS. 7A and 7B show an example embodiment of a sensor C6 in which the parasite flow is eliminated.

The device comprises an element 40 filling the gap between the lower face 2.2 of the moving plate 2 and the support 4 and between the side edges of the moving plate 2 and the support 4 and covering the upper surface 2.1 of the moving plate. The element 40 is sufficiently flexible so that it does not hinder displacement of the moving plate under the effect of the flow on the top face of the moving plate. The element may for example be made from polymer or polyimide. The stiffness of the polymer material under the plate and on the sides of the plate is advantageously at least 10 times lower than the stiffness of the MEMS mechanical structure. The element 40 completely encapsulates the moving plate 2.

The element 40 may for example be deposited by spin-coating at the support, or simply by being dispensed using a syringe on each of the structures, for example after the moving plate 2 has been released.

There is no parasite flow present in this example because no fluid can flow between the moving plate and the support.

It could be arranged that the space between the sensor and the side edges of the recess formed in the wall of the channel should be filled with a material, advantageously preventing the development of turbulence.

FIGS. 8A and 8B show a variant C7 of the sensor in FIGS. 7A and 7B, in which the element 40′ only fills the lateral gap surrounding the moving plate and covers the face 2.1 of the moving plate. It then forms a barrier to the fluid flow between the moving plate and the support and under the moving plate. The element 40′ is for example formed before the moving plate is released through openings made in the back face. The element may for example be made from polymer or polyimide.

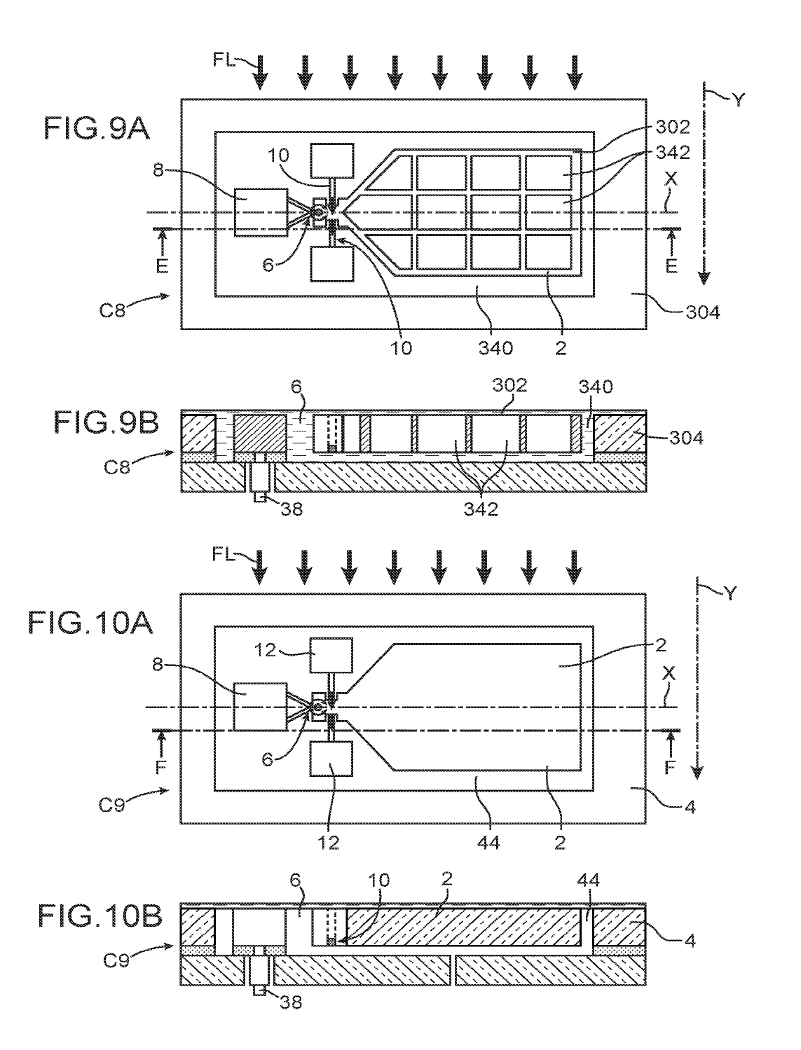

FIGS. 9A and 9B show a variant embodiment C8 of the sensor in FIGS. 7A and 7B, in which the moving plate 302 comprises slots 342 and an element 340 filling the lateral gap between the moving plate 302 and the support 304 and also the gap between the lower face of the moving plate and the support, filling the slots and covering the upper surface of the moving plate. This variant has the advantage of limiting the effect of the fluid pressure on the device. Tangential forces applied by the fluid on the moving plate are then partly transmitted by the flexible material.

FIGS. 10A and 10B show another variant C9 of the sensor in FIGS. 7A and 7B, in which the fluid passage is prevented by means of a dry film 44 deposited on the upper surface of the moving plate, the support and overlapping the lateral gap between the moving plate 2 and the support 4. The moving plate 2 is then partially encapsulated. The film 44 then forms a barrier for the fluid, and parasite flows are then eliminated. The film may for example be made from polymer or polyimide. The dry film may for example be glued or deposited by rolling before or after the moving plate is released.

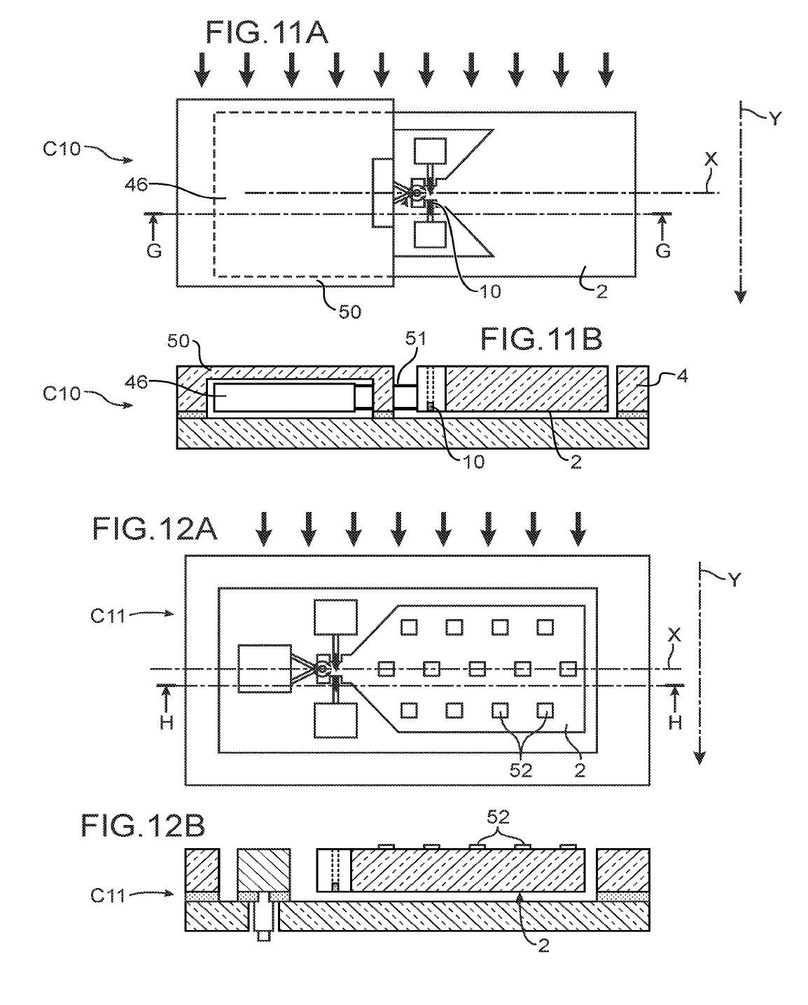

FIGS. 11A and 11B show an example embodiment C10 of a sensor according to the invention with reduced sensitivity to parasite accelerations and vibrations. For example, vibrations could occur in the pipe in which it is required to measure the flow and these vibrations could distort the measurements by displacement of the moving plate under the effect of shear stresses.

Sensor C10 comprises an element 46 forming a counterweight rigidly connected to the moving plate. This counterweight 46 is attached to the moving plate such that the pivot link is located between the moving plate and the counterweight. The device also comprises means 50 of protecting the counterweight 46 from the fluid to be measured so that it does not contribute to the measurement. The means 50 may for example be formed by a lid covering the counterweight 46, and thus the fluid does not come into contact with the upper surface of the counterweight and does not apply any shear stress to it. This counterweight makes the moving plate 2 less sensitive to parasite accelerations and vibrations. Thus, only shear stresses applied by the fluid will affect movement of the moving plate 2 and have an influence on the gauges.

In the example shown, the moving plate 2 and the counterweight 46 are connected together by two beams 51 extending along the X axis on each side of the pivot link. This embodiment is not limitative and any other embodiment will be within the scope of this invention.

FIGS. 12A and 12B show another example embodiment C11 in which the tangential force applied by the flow onto the moving plate is increased. This is done by providing projecting elements 52 on the upper face of the moving plate 2. In the example shown, these are square pads distributed over the entire upper surface of the moving plate. In this case the projections are distributed in lines parallel to the X axis and are in staggered rows. These projections have a limited height such that they do not project outside the zone in which the shear stresses are applied. Preferably, the height of the projections is less than or equal to 100 μm. The shape of these projections is not limitative, and other shapes could be suitable.

According to the invention, a tangential force measurement system is produced for which the sensitivity of the sensor is much higher than the sensitivity achieved in the state of the art by separating the mechanical part from the detection part. Furthermore, the sensor according to the invention applies a lever arm between the moving plate and the gauge(s), which amplifies stresses finally occurring in the gauges, and the sensitivity is further increased. It is also possible to use suspended gauge(s) thinner than the mechanical part of the moving element to increase the stress concentration, which further increases the sensitivity.

The result obtained is that increasing the sensitivity of the sensor makes it possible to reduce the area of the moving plate and therefore the sensor may be made smaller and therefore its spatial resolution can be further increased.

The system according to the invention is particularly suitable for making differential measurements, and for making half or complete Wheatstone bridges.

The invention also uses suspended gauges, which prevents the occurrence of leakage currents at high temperature as occurs with implanted or diffuse gauges of piezoresistive flow meters according to the state of the art. The invention can thus be used to make flow meters that do not have this limitation on the working temperature.

An example embodiment of a sensor used in the system according to the invention will be given.

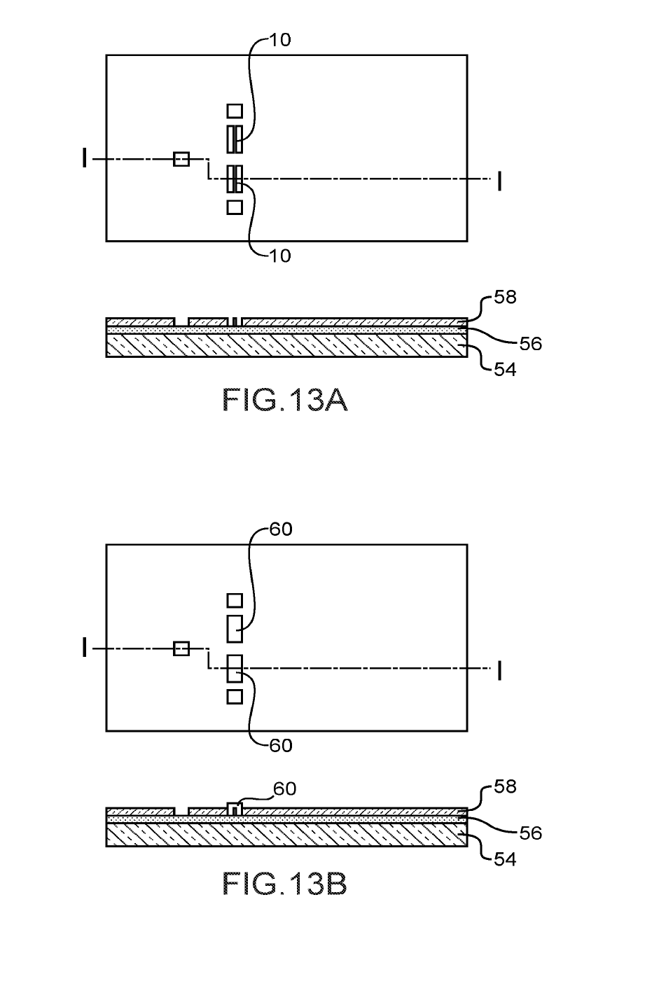

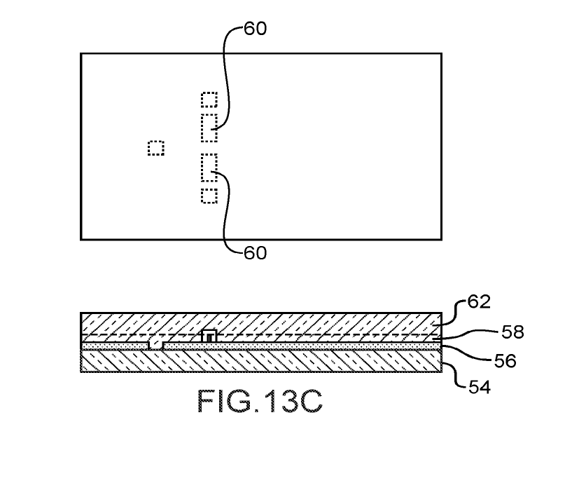

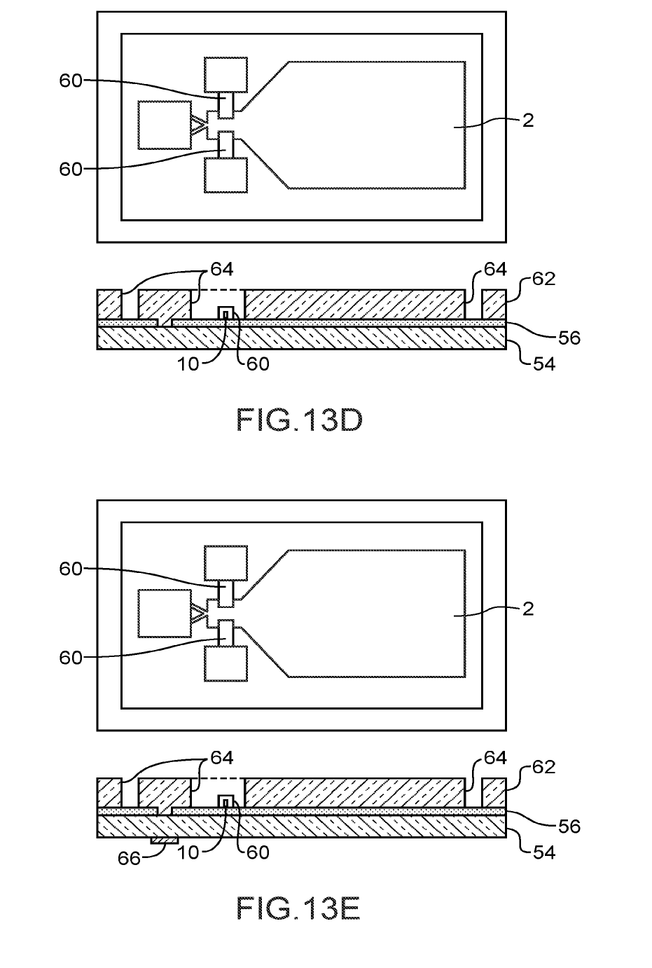

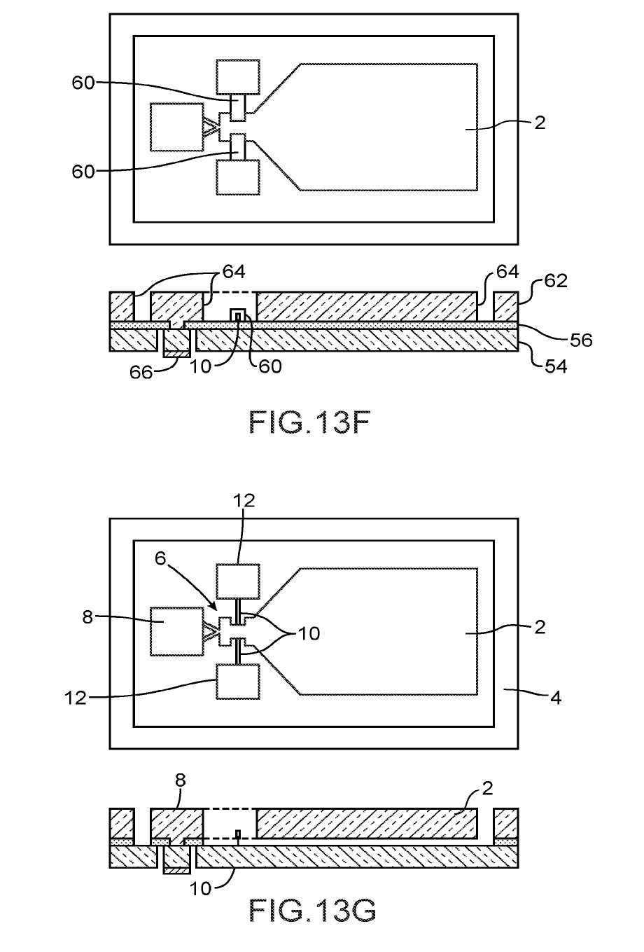

FIGS. 13A to 13G show the different steps in an example method of making a sensor. Each figure shows the element obtained during the different steps, in a top view and in a sectional view along the planes denoted I-I on the top view.

For example, the starting point is an SOI (silicon on insulator) substrate for example comprising a silicon layer 54, a silicon oxide (buried oxide) layer 56, for example 2 μm thick, and a silicon layer 58, for example between a few tens of nm and a few μm thick on the layer 56. The layer 56 forms the sacrificial layer. A stack could also be made by transferring the Si layer 58 onto the stack of layers 54 and 56, or by depositing this layer 58 on the layer 56. The layer 58 is preferably made from monocristalline silicon.

The next step is photolithography, then etching of the silicon layer 58 to define the piezoresistive gauge 10 and define the contact zone with the substrate. Etching is stopped on the SiO₂ layer.

The element thus obtained is shown in FIG. 13A.

An oxide layer is formed in the next step, for example by deposition, for example of SiO₂, and for example between 1 μm and 2 μm thick, that will form a stop layer. For example, the oxide layer will be deposited by Plasma-Enhanced Chemical Vapour Deposition (PECVD).

Photolithography is then performed in order to delimit oxide portions 60 covering the piezoresistive gauges. The oxide layer is then etched stopping on the layer 58, eliminating the layer except at the portion 60. The oxide in the contact zone with the substrate is also etched. Stripping may be done to eliminate etching and stencil residues.

The element thus obtained is shown in FIG. 13B.

A layer 62 is formed for example from silicon on the layer 58 in the next step. The layer 62 is preferably formed by epitaxial growth on the Si layer 58 and on the oxide portions 60. For example, the thickness of this layer may be between 1 μm and a few tens of μm.

Mechanical-chemical polishing can then be done.

The element thus obtained is shown in FIG. 13C.

Photolitography is performed in the next step to delimit the moving part and the anchor pads, and to eliminate the portion 60 above the piezoresistive gauges by selective etching of the layer 62. The vertical etching operations 64 are then made in the thickness of the layer 62, stopping on the oxide layer 56 and the oxide portion 60.1, for example by Deep Reactive Ion Etching (DRIE).

The element thus obtained is shown in FIG. 13D.

The back face of the substrate is metallised in the next step to make the electrical connections. For example, an AlSi layer 66 may be deposited on the entire back face of the substrate.

The next step is lithography and etching of the layer 66, thus defining the contact pads.

The element thus obtained is shown in FIG. 13E.

In a next step, the contact pads are trimmed by etching the substrate from the back face, stopping on the SiO₂ layer 56. Etching may for example be DRIE etching.

The element thus obtained is shown in FIG. 13F.

The moving plate 2 and the pivot link are released in the next step, by partially eliminating the oxide layer 56, and the piezoresistive gauges 10 are released by removing the portion 60.1, for example using sulphuric acid vapour. This is an etching over time. Sulphuric acid is left in contact with the oxide layer 56 and the oxide 60.1 for as long as necessary to release the moving plate and the gauges while leaving the sacrificial layer under the fixed parts of the system.

The element thus obtained is shown in FIG. 13G.

The sensor may for example be made on a board or on a package 67 from which contacts 69 can be extracted (FIG. 15A). A drilling 68 is then made in the side wall of the pipe 22 in which the sensor is to be installed (FIG. 15B) and the sensor is installed in a sealed manner in the drilling 68 through the board or the package 67 and a seal 70 inserted between the package 67 and the outer surface of the pipe 22 such that the moving plate is influenced by the fluid flowing in the pipe 22 (FIG. 15C). The sensor may then be connected to an external system.

It is possible to envisage using a network of sensors.

The device according to the invention is capable of measuring a tangential force applied by a fluid regardless of whether it is a liquid or a gas.

It can then be used to make flow sensors with high sensitivity and it can be used to measure liquid or gas flows. Several sensors may be integrated into the wall of a pipe in one or several recesses or one or several crossings. For example, it may be installed in a gas or water pipe, for example installed in private houses to measure subscriber consumptions.

II may also be used to determine the viscosity of a fluid using the measurement of a known flow.

1-25. (canceled)

26: A measurement system for measuring a tangential force applied by a fluid, said system comprising:
a pipe in which the fluid is intended to flow, the pipe extending over at least a portion along a given direction, referred to as the flow direction, the pipe comprising an inner surface that will be in contact with the fluid, and at least a cavity located in said inner surface of the pipe,
at least one MEMS and/or NEMS device for measuring the tangential force comprising a support with a median plane and a moving plate, said moving plate being suspended from the support by at least one pivot link, said pivot link having a centre line perpendicular to the median plane of the support, said moving plate comprising a first face on which the fluid applies a tangential force and a second face opposite the first face, said device being fixed to the pipe and being located in the cavity such that the first face of the moving plate is flush with at least a zone of the inner surface of the pipe surrounding the cavity, said device also comprising at least one piezoresistive strain gauge suspended from and mechanically connected to the moving plate and the support, said gauge being arranged in the cavity such that the tangential force applied to the first surface of the moving plate by the fluid along the flow direction applies a compression or tension force to said piezoresistive strain gauge.

27: The measurement system according to claim 26, wherein the distance separating the plane containing the first face of the moving plate and the plane containing at least the zone surrounding the cavity is less than or equal to 200 μm.

28: The measurement system according to claim 26, wherein the gauge is located as close to the axis of the pivot link as possible.

29: The measurement system according to claim 26, comprising at least two gauges mounted in differential and electrically connected as a half Wheatstone bridge or at least four gauges mounted in differential and electrically connected as a Wheatstone bridge.

30: The measurement system according to claim 26, wherein the moving plate is suspended from the support by two pivot links, said device comprising at least two piezoresistive gauges.

31: The measurement system according to claim 30, wherein at least one rigid force transmission arm connects the moving plate to each pivot link, at least one piezoresistive strain gauge being suspended between a force transmission arm and the support.

32: The measurement system according to claim 30, wherein each force transmission arm is connected to the moving plate by at least elastically deformable member at least along the direction perpendicular to the fluid flow.

33: The measurement system according to claim 26, wherein the strain gauge is between 100 nm and 500 nm thick and the moving plate is between 3 μm and 40 μm thick.

34: Measurement system according to claim 26, wherein the pivot link comprises two beams with approximately equal lengths anchored onto the support at two separate points and anchored onto the moving plate at a point through which the axis of the pivot link passes.

35: Measurement system according to claim 26, comprising a limiter for limiting the fluid flow between the moving plate and the support.

36: Measurement system according to claim 35, wherein the limiter comprises structuring of the support and/or of the moving plate so as to form at least one low flow section zone between the support and the moving plate.

37: Measurement system according to claim 36, wherein structuring is done on the second face of the moving plate and/or on a zone of the support facing said face.

38: The measurement system according claim 26, comprising a device for preventing fluid flow between the moving plate and the support.

39: The measurement system according to claim 38, wherein the device for preventing comprises a flexible element at least partially encapsulating the moving plate and preventing fluid from flowing between the moving plate and the support.

40: The measurement system according to claim 39, wherein the element is a polymer or a polyimide.

41: The measurement system according to claim 38, wherein the device for preventing comprises a film made from a flexible material covering the first face of the moving plate and at least part of the support.

42: The measurement system according to claim 39, wherein the moving plate comprises slots, said slots being closed off by the flexible element or by the film.

43: The measurement system according to claim 26, comprising a reducer for reducing the sensitivity to parasite accelerations and vibrations.

44: The measurement system according to claim 43, wherein said reducer comprises a counterweight fixed to the moving plate and protected from the fluid so that no tangential force is applied to it.

45: A system to measure the flow rate of a fluid flowing in a pipe comprising at least one measurement system according to claim 26.

46: The method of making a measurement system according to claim 26, this method comprising:
the formation of a cavity in the inner surface of a pipe,
manufacturing of a tangential force measurement device from a stack formed from a substrate, a sacrificial layer and at least a first layer of a conducting or semiconducting material, comprising formation of at least one piezoresistive gauge in the first layer, formation of the moving plate and the at least one pivot link in said stack and release of the gauge, the moving plate and the pivot link.

47: The method of making a measurement system according to claim 46, wherein after the gauge has been formed, a protection portion is formed on said gauge before the formation of a second layer of a conducting or semiconducting material on the first layer of a conducting or semiconducting material.

48: The method of making a measurement system according to claim 47, wherein after the protection portion has been formed, the second layer of a semiconducting, conducting or insulating material is formed on the first layer of a conducting or semiconducting material, and in which the moving plate and the pivot ink are at least partly formed.

49: The method of making a measurement system according to claim 46, comprising a step to fill at least the lateral gap between the moving plate and the support to form the device for preventing fluid flow between the moving plate and the support.

50: The method of making a measurement system according to claim 46, comprising a step in which a film is formed on the moving plate and on at least part of the support so as to close off the lateral gap between the moving plate and the support, to form the device for preventing the fluid flow between the moving plate and the support.

51: The measurement system according to claim 26, wherein the distance separating the plane containing the first face of the moving plate and the plane containing at least the zone surrounding the cavity is less than or equal to 100 μm.
